(19) United States
(12) Patent Application Publication
(10) Pub. No.: US 2026/0268533 A1
(43) Pub. Date: Sep. 10, 2026

(54) METHOD AND DEVICE, EQUIPMENT, STORAGE MEDIUM AND PROGRAM PRODUCT FOR IMAGE DISPLAY

(71) Applicant: Beijing Zitiao Network Technology Co., Ltd., Beijing (CN)

(72) Inventors: Jia GUO, Beijing (CN); Chi FANG, Beijing (CN)

(21) Appl. No.: 19/163,262

(22) PCT Filed: Feb. 28, 2024
(86) PCT No.: PCT/CN2024/079130

§ 371 Date: Sep. 8, 2025

(30) Foreign Application Priority Data
Mar. 8, 2023 (CN) 202310218487.X

(51) Int. Cl. G06T 11/00; G06T 7/70

(52) U.S. Cl. CPC G06T 11/00; G06T 7/70; G06T 2210/62

(57) ABSTRACT

The disclosure provides an method and apparatus, device, a storage medium and a program product for image display, and the method is applied to an intelligent terminal and includes: in response to detecting that a user wears an intelligent terminal, displaying a virtual object, and determining whether a realistic position corresponding to the virtual object in the realistic environment falls into a set area; in accordance with a determination that the realistic position corresponding to the virtual object in a realistic environment falls within a set area, detecting a realistic object around the user, determining an occluded object, and detecting whether a relative distance from the occluded object to the realistic position is not greater than a safety threshold; and in accordance with a determination that a determination that the relative distance from the occluded object to the realistic position is not greater than the safety threshold, adjusting the display transparency of the virtual object based on the relative distance.

### CROSS-REFERENCE

The present application claims priority to Chinese Patent Application No. 202310218487. X, entitled “METHOD, APPARATUS, DEVICE, STORAGE MEDIUM FOR IMAGE DISPLAY, AND PROGRAM PRODUCT”, filed on Mar. 8, 2023, the entire content of which is incorporated herein by reference.

### FIELD

The invention relates to a technical field of augmented reality, in particular to an image display method and apparatus, device, storage medium and program product.

### BACKGROUND

At present, extended reality (XR) technology has gradually gone into people's lives and various related technologies, and the corresponding augmented reality (AR) and virtual reality (VR) devices construct a virtual three-dimensional visual environment by closing the vision of a person, so that people participate in the environment to achieve an immersive experience feeling.

However, due to the fact that current extended reality technology blocks the real vision, when a user wears an extended reality device to move, some potential safety hazards in a real environment cannot be avoided, collision is easy, user experience is reduced, and even personal injury is caused.

### SUMMARY

Based on the foregoing purpose, the present application provides a method for image display, applied to an intelligent terminal, including:
In response to detecting that a user wears the intelligent terminal, displaying a virtual object, and determining whether a realistic position corresponding to the virtual object in a real environment falls within a set area;
in accordance with a determination that the realistic position corresponding to the virtual object in the realistic environment falls within the set area, detecting a realistic object around the user, determining an occluded object occluded by the virtual object in the realistic object, and detecting whether a relative distance from the occluded object to the realistic position is not greater than a safety threshold;
in accordance with a determination that the relative distance from the occluded object to the realistic position is not greater than the safety threshold, adjusting a display transparency of the virtual object based on the relative distance.

In some embodiments, the intelligent terminal is provided with an image sensor;
displaying a virtual object includes:
acquiring an environment image around the user by the image sensor;
displaying the environment image, and inserting the virtual object into the environment image.

In some embodiments, the image sensor includes a laser radar;
acquiring the environment image around the user by the image sensor includes:
performing laser scanning on an environment surrounding the user by the laser radar, generating a point cloud image according to a scanning result, and using the point cloud image as the environment image.

In some implementations, detecting whether the relative distance from the occluded object to the realistic position is not greater than the safety threshold includes:
determining a first position relationship between the occluded object and the user by the image sensor;
determining, based on the first position relationship and a second position relationship between the user and the virtual object, the relative distance from the occluded object to the realistic position, and determining whether the relative distance is not greater than the safety threshold.

In some embodiments, the intelligent terminal is provided with a thermal sensor;
detecting whether the relative distance from the occluded object to the realistic position is not greater than the safety threshold includes:
monitoring thermal radiation of the occluded object by the thermal sensor, and determining a first position relationship between the occluded object and the user based on a change of the thermal radiation;
determining, based on the first position relationship and a second position relationship between the user and the virtual object, the relative distance from the occluded object to the realistic position, and determining whether the relative distance is not greater than the safety threshold.

In some embodiments, adjusting the display transparency of the virtual object based on the relative distance includes:
proportionally increasing the display transparency according to a reduction of the relative distance;
in accordance with a determination that the relative distance is 0, determining the display transparency is 100%.

In some embodiments, after adjusting the display transparency of the virtual object based on the relative distance, the method further includes:
performing object recognition on the occluded object with the relative distance not greater than the safety threshold, and generating text prompt information according to a recognition result.

In some embodiments, generating the text prompt information according to the recognition result includes:
determining position information of the occluded object with the relative distance not greater than the safety threshold, and adjusting a display position of the text prompt information according to the position information, so that the text prompt information is located beside the corresponding occluded object.

In some embodiments, after adjusting the display transparency of the virtual object based on the relative distance, the method further includes:
detecting a light intensity of a realistic environment around the user;
performing, in response to the light intensity being less than a preset threshold, differential display of the occluded object with the relative distance not greater than the safety threshold.

In some implementations, the differential display at least includes: performing tracing processing according to a contour of the occluded object, performing brightness increasing processing on the occluded object, or displaying a prompt identifier beside the occluded object.

Based on the same concept, the present disclosure further provides an image display device, applied to an intelligent terminal, including:
a determining module configured to display a virtual object, in response to detecting that a user wears the intelligent terminal, and determine whether a realistic position corresponding to the virtual object in a realistic environment falls within a set area;
a detection module configured to detect a realistic object around the user if the realistic position falls within the set area, determine an occluded object occluded by the virtual object in the realistic object, and detect whether a relative distance from the occluded object to the realistic position is not greater than a safety threshold;
a display module configured to adjust a display transparency of the virtual object based on the relative distance if the relative distance is not greater than the safety threshold.

Based on the same concept, the present application further provides an electronic device, including a memory, a processor, and a computer program stored in the memory and executable on the processor, the processor, when executing the program, implements the method according to any one of the above.

Based on the same concept, the present disclosure further provides a non-transitory computer-readable storage medium storing computer instructions for causing a computer to implement the method according to any one of the above.

Based on the same concept, the present application further provides a computer program product, including computer program instructions, when the computer program instructions run on a computer, the computer is caused to perform the method according to any one of the above.

### BRIEF DESCRIPTION OF DRAWINGS

In order to more clearly describe technical solutions in embodiments of the present application or related technologies, drawings that need to be used in description of the embodiments or related technologies are briefly described below, and obviously, the drawings in the following description are merely embodiments of the present application, and for those of ordinary skill in the art, other drawings may be obtained based on these drawings without creative work.

FIG. 1 is a schematic flowchart of a method for image display provided by embodiments of the present application;

FIG. 2 is a schematic diagram of a scenario when a occluded object is far away from a virtual object provided by embodiments of the present application;

FIG. 3 is a schematic top view of a occluded object farther from a virtual object provided by embodiments of the present application;

FIG. 4 is a schematic diagram of a scenario when a occluded object is closer to a virtual object provided by embodiments of the present application;

FIG. 5 is a schematic top view of a occluded object closer to a virtual object provided by embodiments of the present application;

FIG. 6 is a schematic diagram of a scenario when an occluded object overlaps with a virtual object provided by embodiments of the present application;

FIG. 7 is a schematic top view of an occluded object overlapping with a virtual object provided by embodiments of the present application;

FIG. 8 is a schematic structural diagram of an image display device provided by embodiments of the present application;

FIG. 9 is a schematic structural diagram of an electronic device provided by embodiments of the present application.

### DETAILED DESCRIPTION

In order to make purposes, technical solutions and advantages of the present specification clearer, the present specification is further described in detail below with reference to the drawings.

It may be understood that, before using the technical solutions disclosed in embodiments of the present application, types of personal information related to the present application, usage scope, usage scenario, and the like should be notified to the user in an appropriate manner according to the relevant laws and regulations, and authorization of the user is obtained.

For example, in response to receiving an active request from a user, prompt information is sent to the user to explicitly prompt the user that the requested operation will need to acquire and use the personal information of the user. Therefore, the user can autonomously select whether to provide personal information to software or hardware executing the operation of the technical solution of the present application according to the prompt information.

As an optional but non-limiting implementation, in response to receiving the active request of the user, a manner of sending the prompt information to the user may be, for example, a pop-up window, and the prompt information may be presented in a text manner in the pop-up window. In addition, the pop-up window may further carry a selection control for the user to select “agree” or “not agree” to provide personal information to an electronic device.

It may be understood that the foregoing processes of notifying and obtaining authorization of the user are merely illustrative, do not constitute a limitation on implementations of the present application, and other manners of meeting related laws and regulations may also be applied to implementations of the present application.

It may be understood that data involved in the technical solution (including but not limited to the data itself, the acquisition or use of the data) should follow requirements of corresponding laws and regulations and related regulations.

In order to make the purposes, technical solutions and advantages of the present specification clearer, the present specification is further described in detail below with reference to the drawings.

It should be noted that, unless otherwise defined, technical terms or scientific terms used in the embodiments of the present application should be of ordinary meanings understood by those skilled in the art to which the present application belongs. The terms “first”, “second” and similar terms used in the embodiments of the present application do not represent any order, quantity, or importance, but are merely used to distinguish different components. A word “comprising” or “including” or the like means that an element, object, or method step that appears in front of the word encompasses elements, objects, or method steps that appear behind the word and equivalents thereof, without excluding other elements, objects, or method steps. Similar terms such as “connected” or “linked” are not limited to physical or mechanical connections, but may include electrical connections, whether direct or indirect. “Upper”, “lower”, “left”, “right” and the like are only used to represent relative position relationships, and when the absolute position of the object to be described changes, the relative position relationship may also change accordingly.

As described in the background, extended reality (extended reality, XR for short) refers to a general term of a plurality of technologies, such as augmented reality (AR), virtual reality (VR), mixed reality (MR), and the like, by combining real and virtual through a computer. By fusing the visual interaction techniques of the three, a seamless transition “immersion” between the virtual world and the real world is brought to the experiencer. In the XR technology, the user may be allowed to interact with the virtual digital world, thereby providing a richer experience for the user. VR technology and AR technology also make users increasingly popular for the non-trivial ability of digital world perception. When the user uses a XR device, the user generally wears the device such as XR glasses, so that the user can see a virtual environment and a virtual scene generated by the system for the user, the scene can be superimposed on a realistic scene, or only the virtual scene can be displayed. However, this may hinder the user's perception of things in the realistic environment, which may bring some security risks to the user. For example, a past pedestrian, a pet in a home disorder, and some smart home appliances (a sweeper, a mobile device, etc.) may collide with a user. Therefore, the user experience is reduced, and even personal injury is caused.

In view of this, the present disclosure provides an method, apparatus, device, a storage medium, and a program product for image display, to resolve a problem that some potential safety hazards in a realistic environment cannot be seen when a user wears an extended reality device, so that a user can detect in advance and respond earlier, improve user experience, and avoid harm.

The present application provides an method and apparatus, device, a storage medium and a program product for image display, and the method is applied to an intelligent terminal and comprises: in response to detecting that a user wears the intelligent terminal, displaying a virtual object, and determining whether a realistic position corresponding to the virtual object in the realistic environment falls into a set area; in accordance with a determination that the realistic position corresponding to the virtual object in the realistic environment falls within the set area, detecting a realistic object around the user, determining an occluded object occluded by the virtual object in the realistic object, and detecting whether a relative distance from the occluded object to the realistic position is not greater than a safety threshold; and in accordance with a determination that the relative distance from the occluded object to the realistic position is not greater than the safety threshold, adjusting a display transparency of the virtual object based on the relative distance. According to the method, when the user wears the intelligent terminal, the distance between the occluded object occluded by the virtual object in the set area in the realistic object and the virtual object in the realistic object is monitored at all times, and for the virtual object with the distance not greater than the safety threshold, the virtual object is transparentized, so that the occluded object is presented in front of the user, so that the user can detect in advance and respond earlier, experience of the user is improved, and the injury is avoided.

With reference to the foregoing actual situation, an embodiment of the present application provides an solution for image display. According to the method, when the user wears the intelligent terminal, the distance between the occluded object occluded by the virtual object in the set area in the realistic object and the virtual object in the realistic object is monitored at all times, and for the virtual object with the distance not greater than the safety threshold, the virtual object is transparentized, so that the occluded object is presented in front of the user, so that the user can detect in advance and respond earlier, the experience of the user is improved, and the injury is avoided.

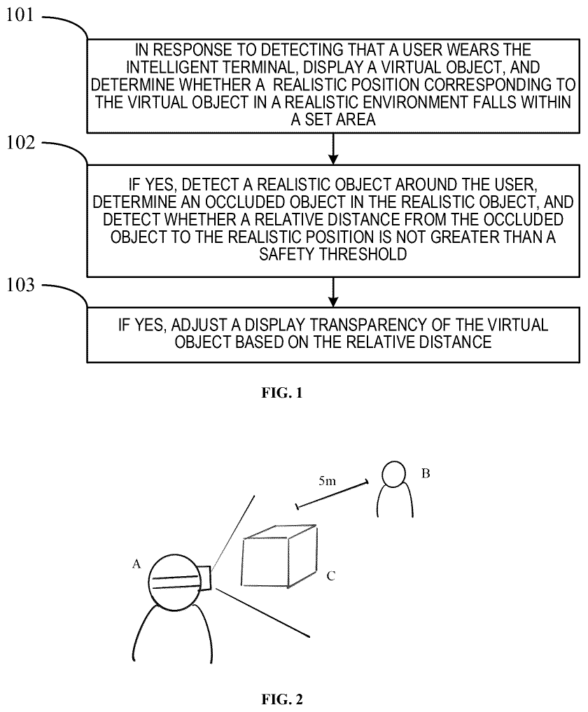

FIG. 1 is a schematic flowchart of an method for image display provided by the present application. The method is applied to an intelligent terminal, and specifically includes:

Step 101, in response to detecting that a user wears the intelligent terminal, displaying a virtual object, and determining whether a realistic position corresponding to the virtual object in the realistic environment falls within a set area.

In some embodiments, the intelligent terminal refers to a modern intelligent electronic device, for example, XR glasses, an XR headset, a mobile phone, an iPad, and the like, capable of performing numerical calculation, logical operation, and having a memory storage function, and capable of performing corresponding operations according to instructions of a user. Then, the intelligent terminal may perform an image acquisition operation by setting an image sensor or the like, and may present images on the intelligent terminal by acquiring an external image, for example, presenting the reality environment, or presenting an image of the realistic object. The image sensor is a device, such as a camera, which can receive external optical signals and can process the optical signals into image frames. In addition, the image sensor may further include a plurality of optical receiving devices, such as a common camera, an infrared camera, a laser camera, and the like, and images of different requirements are presented by different optical receiving devices.

After detecting that the user wears the intelligent terminal, the virtual object may be displayed on the intelligent terminal for the user to watch, the virtual objects may be some forms, illustrations, or virtual objects, persons, and the like set by the user, and the intelligent terminal may display the virtual objects at any position in a current display scene, wherein the current display scene may be a completely virtual scene, or may be a realistic scene reflecting a surrounding environment where the current user is located, and the like.

Then, a safety area, that is, a set area, may be determined for the user in the realistic environment, and the range of the safety area may be adjusted arbitrarily according to settings of the user, for example, a circle (or sphere) with a radius of 10 meters centered on the user may be set in the realistic environment as the safety area. The setting of the security area may be understood as a protection scope of the user, and it is considered that something in the reality may affect the user only when approaching the security area or entering the security area. Then, it may be determined one by one whether the displayed position of each virtual object is within the safety area. When displaying a virtual object, the intelligent terminal may set a corresponding position and distance in order to make it more hierarchical or correspond to a thing in a scene (virtual or reality). The point location corresponding to the virtual object in reality can be considered as its reality location.

Step 102, in accordance with a determination that the realistic position corresponding to the virtual object in the realistic environment falls within the set area, detecting a realistic object around the user, determining an occluded object in the realistic object occluded by the virtual object, and detecting whether a relative distance from the occluded object to the realistic position is not greater than a safety threshold.

In some embodiments, after detecting that the position of one virtual object is within the safety area, the position detection may be further performed on the object in the realistic environment where the user is located, so as to determine, according to the relative position relationship, which of the things are occluded objects that are occluded by the virtual object, and the occluded objects may be partially occluded or all occluded realistic objects. Further, distances between the occluded objects and the point locations (realistic positions) corresponding to the virtual objects may be calculated. The things in the realistic environment are realistic objects, and the realistic objects may be activities, for example, walking people, cat dogs, running vehicles, running floor sweeping robots, and the like; may also be stationary objects, for example, trees, table chairs, and the like, because the user wearing the intelligent device may also be in a moving state, so that relative position relationships, blocking relationships, and the like of the things may also change.

Thereafter, a safety threshold of a relative distance may be preset, and the safety threshold is used to determine which occluded objects are of interest and which are temporarily not concerned. For example, the safety threshold is set to be 5 meters. When the distance between any occluded object and the realistic position corresponding to the virtual object is less than or equal to 5 m, it is considered that the occluded object needs to be concerned, so that the user needs to be reminded.

Step 103: In accordance with a determination that the relative distance from the occluded object to the realistic position is not greater than the safety threshold, adjust a display transparency of the virtual object based on the relative distance.

In some embodiments, after determining that a occluded object needs to be concerned, in order to remind the user, it is necessary to transparentize the involved virtual object (i.e., the virtual object that occludes the occluded object). Since the distance between the occluded object and the virtual object is not greater than the safety threshold, it may be considered that the virtual object prevents the user from seeing the occluded object, which may adversely affect the user. In order to display the occluded object, it is necessary to transparentize an occlusion (the virtual object), which may adjust transparency according to the distance between the occlusion and the occlusion, the closer the distance is, the higher the transparency of the virtual object is, and the farther the distance is, the lower the transparency of the virtual object is. The transparency is a degree of transparency of one thing, generally from 0% to 100%, and when the object is completely opaque, the object is completely transparent. Through the transparent processing of the virtual object, the occluded object is exposed, and the user can see the occluded object, so that the user is alerted.

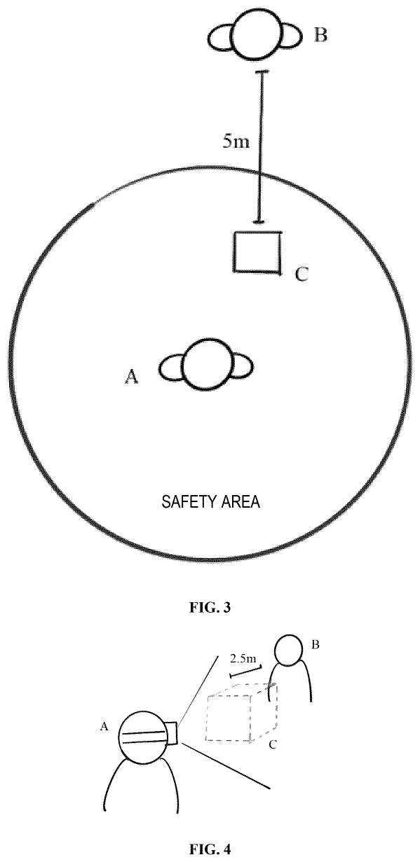

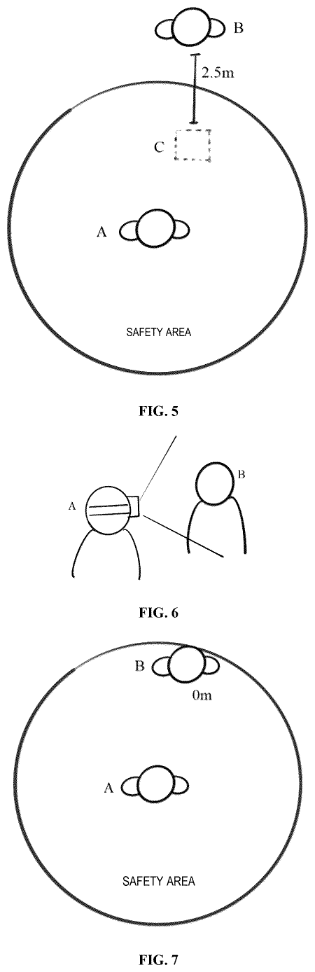

In some embodiments, as shown in FIGS. 2 to 7, A is a user wearing the intelligent terminal, B is a occluded object in the realistic object, and C is a virtual object. As shown in FIGS. 2 and 3, when the distance between the occluded object B and the virtual object C is 5 meters, the distance between the occluded object B and the virtual object C is monitored, and at this time, the transparency of the virtual object C is 0%. As shown in FIGS. 4 and 5, when the distance between the occluded object B and the virtual object C is 2.5 meters, the transparency of the virtual object C may be 50%. As shown in FIGS. 6 and 7, when the distance between the occluded object B and the virtual object C is 0 meters, the transparency of the virtual object C may be 100%.

As may be seen from the above, the method for image display provided by the present application is applied to the intelligent terminal, and includes: in response to detecting that the user wears the intelligent terminal, displaying the virtual object, and determining whether the realistic position corresponding to the virtual object in a realistic environment falls within the set area; in accordance with a determination that the realistic position corresponding to the virtual object in the realistic environment falls within the set area, detecting the realistic object around the user, determining the occluded object occluded by the virtual object in the realistic object, and detecting whether the relative distance from the occluded object to the realistic position is not greater than the safety threshold; in accordance with a determination that the relative distance from the occluded object to the realistic position is not greater than the safety threshold, adjusting the display transparency of the virtual object based on the relative distance. According to the method, when the user wears the intelligent terminal, the distance between the occluded object shielded by the virtual object in the set area in the realistic object and the virtual object in the realistic object is monitored at all times, and for the virtual object with the distance not greater than the safety threshold, the virtual object is transparentized, so that the occluded object is presented in front of the user, so that the user can detect in advance and respond earlier, experience of the user is improved, and injury is avoided.

In some embodiments, the intelligent terminal is provided with an image sensor; displaying the virtual object includes: acquiring an environment image around the user by the image sensor; and displaying the environment image, and inserting the virtual object into the environment image.

In some embodiments, the intelligent terminal such as an extended reality device may perform scene display in a video see-through manner, that is, a scene in reality may be directly or indirectly viewed through the XR glasses device. That is, the environment image around the user can be acquired by the image sensor; and after that, when the environment image is displayed, the virtual object is inserted into the environment image to realize the scene and thing display of the extended reality.

In some embodiments, the image sensor includes a laser radar; acquiring the environment image around the user by the image sensor includes: performing laser scanning on an environment surrounding the user by the laser radar, generating a point cloud image according to a scanning result, and using the point cloud image as the environment image.

The image sensor may be a laser radar, a laser radar (LiDAR, Laser Detecting and Ranging), that is, a laser detection and ranging. Similar to the radar working principle, the laser radar performs image imaging by transmitting and receiving laser beams. In the embodiment, after the laser radar completes scanning around the surrounding by receiving and receiving the laser beams, the distance is determined by measuring the time difference and the phase difference of the receiving and receiving laser signals, the angle is measured by horizontal rotation scanning, a two-dimensional polar coordinate system is established according to the two parameters, and then the height information in the three-dimensional is obtained by acquiring different pitching angle signals. The high-frequency laser can acquire a large number (about 1500 million) of position point information (called point clouds) in one second, and perform three-dimensional modeling according to the information. The final three-dimensional modeling completed image is the point cloud image.

In some embodiments, detecting whether a relative distance from the occluded object to the realistic position is not greater than the safety threshold comprises: determining a first position relationship between the occluded object and the user by the image sensor; determining, based on the first position relationship and a second position relationship between the user and the virtual object, the relative distance from the occluded object to the realistic position, and determining whether the relative distance is not greater than the safety threshold.

In some embodiments, since the user wears the intelligent terminal, it is easier to determine the position relationship between the occluded object and the user by the image sensor, such as how much the distance is, how much the angle is between, and the first position relationship is easier to determine. Then, since the virtual object is generally generated by the intelligent terminal, the relationship between the position of the virtual object and the user is generally fixed, set, or easy to calculate, that is, the second position relationship is easier to determine. Then, after the first position relationship and the second position relationship are obtained, the triangular relationship formed by the three point positions has been determined, and then the relative distance between the occluded object and the corresponding reality position of the virtual object in the realistic environment may be calculated by using the first position relationship and the second position relationship. A determination of a size between the relative distance and the safety threshold is completed.

In some embodiments, the intelligent terminal is provided with a thermal sensor; detecting whether the relative distance from the occluded object to the realistic position is not greater than the safety threshold includes: monitoring thermal radiation of the occluded object by the thermal sensor, and determining a first position relationship between the occluded object and the user based on a change of the thermal radiation; and determining, based on the first position relationship and a second position relationship between the user and the virtual object, the relative distance from the occluded object to the realistic position, and determining whether the relative distance is not greater than the safety threshold.

In some embodiments, similar to the previous embodiment, in order to conveniently detect a temperature occluded object, temperature monitoring may be performed by using a thermal sensor. The thermal sensor such as a thermal imager converts invisible infrared energy emitted by an object into a visible thermal image. The different colors above the thermal image represent different temperatures of the object under test. By viewing the thermal image, the overall temperature distribution condition of the target to be measured can be observed, the heating condition of the target is researched, and the next operation is judged. The working principle of modern thermal imagers is to use optoelectronic devices to detect and measure radiation and to establish mutual connections between radiation and surface temperature. Thereafter, the thermal intensity values may be encoded with pixels of the thermal image, the thermal intensity values representing relative amounts of thermal energy received by the thermal imager from objects in the environment. The amount of thermal energy received by the thermal imager from the object may vary from the thermal imager to the object. Therefore, the first position relationship can be quickly determined through the thermal sensor, and the second position relationship is relatively easy to obtain or preset in advance, so that the relative distance calculation is performed according to the first position relationship and the second position relationship, and then compared with the safety threshold. The thermal sensor may be used in a scene with poor light or complicated structure.

In some embodiments, adjusting the display transparency of the virtual object based on the relative distance includes: proportionally increasing the display transparency according to a reduction of the relative distance; and in accordance with a determination that the relative distance is 0, determining the display transparency is 100%.

In some embodiments, in order to gradually remind the user as the occluded object approaches. The display transparency can be gradually increased according to the reduction of the relative distance, gradually cause the user to clearly see the occluded object and attention degree can be improved.

In some embodiments, after adjusting the display transparency of the virtual object based on the relative distance, the method further includes: performing object recognition on the occluded object with the relative distance not greater than the safety threshold, and generating text prompt information according to a recognition result.

In some embodiments, in order to further improve the prompt effect, object recognition may be performed on the occluded object to determine what things are close to the user. After the recognition is completed, corresponding text prompt information is generated according to the recognition result. For example, if the occluded object is identified as a vehicle, a text prompt close to the vehicle is generated, the virtual object gradually lightened is matched, and the occluded object gradually and clearly displayed together remind the user.

In some embodiments, generating text prompt information according to the recognition result includes: determining position information of the occluded object with the relative distance not greater than the safety threshold, and adjusting a display position of the text prompt information according to the position information, so that the text prompt information is located beside the corresponding occluded object.

In some embodiments, in order to further improve the prompt effect of the text information, the text prompt information may be set aside from the occluded object for display, since the text prompt information is virtual and the occluded object is in reality, the display position of the text prompt information generally needs to be determined first, and at this time, the display position of the text prompt information is determined by determining the position information of the occluded object, so that the text prompt information is displayed beside the occluded object.

In some embodiments, after adjusting the display transparency of the virtual object based on the relative distance, the method further includes: detecting a light intensity of a realistic environment around the user; and performing, in response to the light intensity being less than a preset threshold, differential display of the occluded object with the relative distance not greater than the safety threshold.

In some embodiments, in order to clearly prompt the user in a dark scene and further improve the prompt effect, the occluded object may be displayed differently. The light intensity reflects the brightness of the realistic environment, indicating whether the user is now in a bright environment or a darker environment. In an environment with a small light intensity, each thing is relatively difficult to be perceived by a user due to the darker light. Therefore, the shading can be performed according to the outline of the object to be occluded, and the shading can be carried out by using a brighter color, so that the object can be highlighted in the scene to remind the user; the image of the object to be occluded can be highlighted, the brightness of the object can be improved, the scene can be highlighted, and the user can be reminded; and a prompt or prompt identifier can be directly generated beside the image of the object to be occluded, so that the user can be reminded. That is, the differential display includes at least: performing tracing processing according to a contour of the occluded object, performing brightness increasing processing on the occluded object, or displaying a prompt identifier beside the occluded object.

It should be noted that the method in this embodiment of the present application may be performed by a single device, for example, a computer or a server. The method in this embodiment of the present application may also be applied to a distributed scenario, and the plurality of devices cooperate to complete. In this distributed scenario, one of the plurality of devices may execute only one or more steps in the method in the embodiments of the present application, and the plurality of devices interact with each other to complete the method.

It should be noted that the foregoing describes a specific embodiment of the present application. Other embodiments are within the scope of the appended claims. In some cases, the acts or steps recited in the claims may be performed in a different order than in the above embodiments and still achieve the desired results. Additionally, the processes depicted in the figures do not necessarily require a particular order or sequential order shown to achieve the desired results. In certain embodiments, multitasking and parallel processing are also possible or may be advantageous.

Based on the same concept, the present disclosure further provides an apparatus for image display corresponding to any of the above embodiments.

Referring to FIG. 8, the apparatus for image display is applied to an intelligent terminal, including:
a determining module 210 configured to display a virtual object in response to detecting that a user wears the intelligent terminal, and determine whether a realistic position corresponding to the virtual object in a realistic environment falls within a set area.

A detection module 220 configured to detect a realistic object around the user if the realistic position falls within the set area, determine an occluded object in the realistic object occluded by the virtual object, and detect whether a relative distance from the occluded object to the realistic position is not greater than a safety threshold.

The display module 230 configured to adjust a display transparency of the virtual object based on the relative distance if the relative distance is not greater than the safety threshold.

For convenience of description, the above apparatus is described when the above apparatus is described. Certainly, when implementing the embodiments of the present application, functions of the modules may be implemented in one or more software and/or hardware.

The apparatus of the foregoing embodiment is configured to implement the corresponding method for image display in the above embodiments, and has the beneficial effects of the corresponding method embodiments, and details are not described herein again.

In some embodiments, the intelligent terminal is provided with an image sensor;

The determining module 210 is further configured to:
acquire an environment image around the user by the image sensor;
display the environment image, and inserting the virtual object into the environment image.

In some embodiments, the image sensor includes a laser radar;

The determining module 210 is further configured to:
perform laser scanning on an environment surrounding the user by the laser radar, generate a point cloud image according to a scanning result, and use the point cloud image as the environment image.

In some embodiments, the detection module 220 is further configured to:
determine a first position relationship between the occluded object and the user by the image sensor;
determine, based on the first position relationship and a second position relationship between the user and the virtual object, the relative distance from the occluded object to the realistic position, and determine whether the relative distance is not greater than the safety threshold.

In some embodiments, the intelligent terminal is provided with a thermal sensor;

The detection module 220 is further configured to:
monitor thermal radiation of the occluded object by the thermal sensor, and determine a first position relationship between the occluded object and the user based on a change of the thermal radiation;
determine, based on the first position relationship and a second position relationship between the user and the virtual object, the relative distance from the occluded object to the realistic position, and determine whether the relative distance is not greater than the safety threshold.

In some embodiments, the display module 230 is further configured to:
proportionally increase the display transparency based ono the relative distance;
in accordance with a determination that the relative distance is 0, determining the display transparency is 100%.

In some embodiments, the display module 230 is further configured to:
perform object recognition on the occluded object with the relative distance not greater than the safety threshold, and generating text prompt information according to a recognition result.

In some embodiments, the display module 230 is further configured to:
determine position information of the occluded object whose relative distance is not greater than the safety threshold, and adjust a display position of the text prompt information according to the position information, so that the text prompt information is located beside the corresponding occluded object.

In some embodiments, the display module 230 is further configured to:
detect a light intensity of a realistic environment around the user;
perform, in response to the light intensity being less than a preset threshold, differential display of the occluded object with the relative distance not greater than the safety threshold.

In some embodiments, the differential display includes at least: perform tracing processing according to a contour of the occluded object, performing brightness increasing processing on the occluded object, or displaying a prompt identifier beside the occluded object.

Based on the same concept, the present disclosure further provides an electronic device, including a memory, a processor, and a computer program stored in the memory and executable on the processor, wherein the processor, when executing the program, implements the method for image display according to any one of the above embodiments.

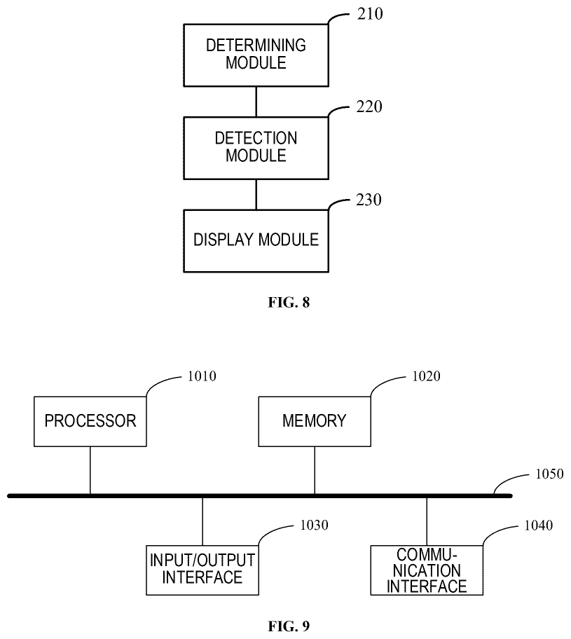

FIG. 9 is a schematic structural diagram of a more specific hardware structure of an electronic device according to this embodiment, and the device may include a processor 1010, a memory 1020, an input/output interface 1030, a communications interface 1040, and a bus 1050. The processor 1010, the memory 1020, the input/output interface 1030, and the communications interface 1040 implement, by using the bus 1050, a communication connection with each other inside the device.

The processor 1010 may be implemented by using a general-purpose central processing unit (CPU), a microprocessor, an application specific integrated circuit (ASIC), or one or more integrated circuits, and is configured to execute related programs to implement the technical solutions provided in the embodiments of the present specification.

The memory 1020 may be implemented in a form of a ROM (Read Only Memory), a Random Access Memory (RAM), a static storage device, a dynamic storage device, or the like. The memory 1020 may store an operating system and other applications, and when implementing the technical solutions provided in the embodiments of the present specification by using software or firmware, related program code is stored in the memory 1020 and invoked and executed by the processor 1010.

The input/output interface 1030 is configured to connect the input/output module to implement information input and output. The input/output module may be configured as a component in the device (not shown in the figure), or may be externally connected to the device to provide a corresponding function. The input device may include a keyboard, a mouse, a touch screen, a microphone, various sensors, etc., and the output device may include a display, a speaker, a vibrator, an indicator light, and the like.

The communications interface 1040 is configured to connect a communications module (not shown in the figure), to implement communications interaction between the device and another device. The communications module may implement communications in a wired manner (for example, a USB or a network cable), or may implement communications in a wireless manner (for example, a mobile network, a Wi-Fi, a Bluetooth, and the like).

The bus 1050 includes a path to transfer information between various components of the device, such as the processor 1010, the memory 1020, the input/output interface 1030, and the communication interface 1040.

It should be noted that although the foregoing device only shows the processor 1010, the memory 1020, the input/output interface 1030, the communications interface 1040, and the bus 1050, in a specific implementation process, the device may further include other components necessary to implement normal running. In addition, those skilled in the art may understand that the foregoing device may also include only components necessary for implementing the solutions in the embodiments of the present specification, and does not necessarily include all components shown in the figure.

The electronic device of the foregoing embodiment is configured to implement the corresponding method for image display in any one of the above embodiments, and has the beneficial effects of the corresponding method embodiments, and details are not described herein again.

Based on the same concept, the present disclosure further provides a non-transitory computer-readable storage medium storing computer instructions for causing the computer to perform the method for image display according to any one of the above embodiments.

Computer-readable media of the present embodiments include permanent and non-permanent, removable and non-removable media, which may be implemented by any method or technology. The information may be computer readable instructions, data structures, modules of a program, or other data. Examples of computer storage media include, but are not limited to, phase change memory (PRAM), static random access memory (SRAM), dynamic random access memory (DRAM), other types of random access memory (RAM), read only memory (ROM), electrically erasable programmable read only memory (EEPROM), flash memory or other memory technology, compact disc read-only memory (CD-ROM), digital versatile disc (DVD) or other optical storage, magnetic cassettes, magnetic tape disk storage or other magnetic storage devices, or any other non-transmission medium, which can be used to store information that can be accessed by a computing device.

The computer instructions stored in the storage medium in the foregoing embodiments are configured to cause the computer to perform the method for image display according to any one of the foregoing embodiments, and have the beneficial effects of the corresponding method embodiments, and details are not described herein again.

Based on the same concept, corresponding to the method for image display according to any one of the above embodiments, the present disclosure further provides a computer program product, including a computer program instruction. In some embodiments, the computer program instructions may be executed by one or more processors of a computer to cause the computer and/or the processor to perform the method for image display. Corresponding to the executing body corresponding to each step in the embodiments of the method for image display, the processor executing the corresponding step may belong to the corresponding executing body.

The computer program product of the above embodiment is configured to cause the computer and/or the processor to perform the method for image display according to any one of the above embodiments, and has the beneficial effects of the corresponding method embodiments, and details are not described herein again.

It should be understood by those of ordinary skill in the art that the foregoing discussion of any embodiment is merely exemplary, and is not intended to suggest that the scope of the present application (including the claims) is limited to these examples; in the spirit of the present application, the above embodiments or the technical features in different embodiments may also be combined, and the steps may be implemented in any order, and there are many other changes in different aspects of the embodiments of the present application as described above.

Additionally, for simplicity of illustration and discussion, and to not obscure embodiments of the present application, well-known power/ground connections to integrated circuit (IC) chips and other components may or may not be shown in the figures provided. Furthermore, the apparatus may be shown in block diagram form in order to avoid obscuring the embodiments of the present application, and this also takes into account the fact that the details regarding the implementation of these block diagram devices are highly dependent on the platform in which the embodiments of the present application are to be implemented (i.e., these details should be fully within the understanding of those skilled in the art). Having set forth specific details (e.g., circuits) to describe exemplary embodiments of the present application, it will be apparent to those skilled in the art that embodiments of the present application may be practiced without these specific details or with changes to these specific details. Accordingly, these descriptions should be considered illustrative and not limiting.

Although the present application has been described in conjunction with specific embodiments of the present application, many alternatives, modifications and variations of these embodiments will be apparent to those of ordinary skill in the art from the foregoing description. For example, other memory architectures (e.g., dynamic RAM (DRAM)) may use the embodiments discussed.

The present application is intended to cover all such alternatives, modifications and variations that fall within the broad scope of the appended claims. Therefore, any omission, modification, equivalent replacement, improvement and the like that are made within the spirit and principle of the embodiments of the present application should be included within the protection scope of the present application.

1. A method for image display, applied to an intelligent terminal, comprising:
in response to detecting that a user wears the intelligent terminal, displaying a virtual object, and determining whether a realistic position corresponding to the virtual object in a realistic environment falls within a set area;
in accordance with a determination that the realistic position corresponding to the virtual object in the realistic environment falls within the set area, detecting a realistic object around the user, determining an occluded object occluded by the virtual object in the realistic object, and detecting whether a relative distance from the occluded object to the realistic position is not greater than a safety threshold; and
in accordance with a determination that the relative distance from the occluded object to the realistic position is not greater than the safety threshold, adjusting a display transparency of the virtual object based on the relative distance.

2. The method of claim 1, wherein the intelligent terminal is provided with an image sensor;
displaying the virtual object comprises:
acquiring an environment image around the user by the image sensor; and
displaying the environment image, and inserting the virtual object into the environment image.

3. The method of claim 2, wherein the image sensor comprises a laser radar, and
acquiring the environment image around the user by the image sensor comprises:
performing laser scanning on an environment surrounding the user by the laser radar, generating a point cloud image according to a scanning result, and using the point cloud image as the environment image.

4. The method of claim 2, wherein detecting whether the relative distance from the occluded object to the realistic position is not greater than the safety threshold comprises:
determining a first position relationship between the occluded object and the user by the image sensor; and
determining, based on the first position relationship and a second position relationship between the user and the virtual object, the relative distance from the occluded object to the realistic position, and determining whether the relative distance is not greater than the safety threshold.

5. The method of claim 1, wherein the intelligent terminal is provided with a thermal sensor;
detecting whether the relative distance from the occluded object to the realistic position is not greater than the safety threshold comprises:
monitoring thermal radiation of the occluded object by the thermal sensor, and determining a first position relationship between the occluded object and the user based on a change of the thermal radiation; and
determining, based on the first position relationship and a second position relationship between the user and the virtual object, the relative distance from the occluded object to the realistic position, and determining whether the relative distance is not greater than the safety threshold.

6. The method of claim 1, wherein adjusting the display transparency of the virtual object based on the relative distance comprises:
proportionally increasing the display transparency according to a reduction of the relative distance; and/or
in accordance with a determination that the relative distance is 0, determining the display transparency is 100%.

7. The method of claim 1, wherein after adjusting the display transparency of the virtual object based on the relative distance, the method further comprises:
performing object recognition on the occluded object with the relative distance not greater than the safety threshold, and generating text prompt information according to a recognition result.

8. The method of claim 7, wherein generating the text prompt information according to the recognition result comprises:
determining position information of the occluded object with the relative distance not greater than the safety threshold, and adjusting a display position of the text prompt information according to the position information, so that the text prompt information is located beside the corresponding occluded object.

9. The method of claim 1, wherein after adjusting the display transparency of the virtual object based on the relative distance, the method further comprises:
detecting a light intensity of a realistic environment around the user; and
performing, in response to the light intensity being less than a preset threshold, differential display of the occluded object with the relative distance not greater than the safety threshold.

10. The method of claim 9, wherein the differential display at least comprises:
performing tracing processing according to a contour of the occluded object, performing brightness increasing processing on the occluded object, or displaying a prompt identifier beside the occluded object.

11. (canceled)

12. An electronic device, comprising a memory, a processor, and a computer program stored in the memory and executable on the processor, wherein the processor, when executing the program, implements acts, comprising:
in response to detecting that a user wears the intelligent terminal, displaying a virtual object, and determining whether a realistic position corresponding to the virtual object in a realistic environment falls within a set area;
in accordance with a determination that the realistic position corresponding to the virtual object in the realistic environment falls within the set area, detecting a realistic object around the user, determining an occluded object occluded by the virtual object in the realistic object, and detecting whether a relative distance from the occluded object to the realistic position is not greater than a safety threshold; and
in accordance with a determination that the relative distance from the occluded object to the realistic position is not greater than the safety threshold, adjusting a display transparency of the virtual object based on the relative distance.

13. A non-transitory computer-readable storage medium storing computer instructions for causing a computer to implement acts comprising:
in response to detecting that a user wears the intelligent terminal, displaying a virtual object, and determining whether a realistic position corresponding to the virtual object in a realistic environment falls within a set area;
in accordance with a determination that the realistic position corresponding to the virtual object in the realistic environment falls within the set area, detecting a realistic object around the user, determining an occluded object occluded by the virtual object in the realistic object, and detecting whether a relative distance from the occluded object to the realistic position is not greater than a safety threshold; and
in accordance with a determination that the relative distance from the occluded object to the realistic position is not greater than the safety threshold, adjusting a display transparency of the virtual object based on the relative distance.

14. (canceled)

15. The electronic device of claim 12, wherein the intelligent terminal is provided with an image sensor;
displaying the virtual object comprises:
acquiring an environment image around the user by the image sensor; and
displaying the environment image, and inserting the virtual object into the environment image.

16. The electronic device of claim 15, wherein the image sensor comprises a laser radar, and
acquiring the environment image around the user by the image sensor comprises:
performing laser scanning on an environment surrounding the user by the laser radar, generating a point cloud image according to a scanning result, and using the point cloud image as the environment image.

17. The electronic device of claim 15, wherein detecting whether the relative distance from the occluded object to the realistic position is not greater than the safety threshold comprises:
determining a first position relationship between the occluded object and the user by the image sensor; and
determining, based on the first position relationship and a second position relationship between the user and the virtual object, the relative distance from the occluded object to the realistic position, and determining whether the relative distance is not greater than the safety threshold.

18. The electronic device of claim 12, wherein the intelligent terminal is provided with a thermal sensor;
detecting whether the relative distance from the occluded object to the realistic position is not greater than the safety threshold comprises:
monitoring thermal radiation of the occluded object by the thermal sensor, and determining a first position relationship between the occluded object and the user based on a change of the thermal radiation; and
determining, based on the first position relationship and a second position relationship between the user and the virtual object, the relative distance from the occluded object to the realistic position, and determining whether the relative distance is not greater than the safety threshold.

19. The electronic device of claim 12, wherein adjusting the display transparency of the virtual object based on the relative distance comprises:
proportionally increasing the display transparency according to a reduction of the relative distance; and/or
in accordance with a determination that the relative distance is 0, determining the display transparency is 100%.

20. The electronic device of claim 12, wherein after adjusting the display transparency of the virtual object based on the relative distance, the acts further comprise:
performing object recognition on the occluded object with the relative distance not greater than the safety threshold, and generating text prompt information according to a recognition result.

21. The electronic device of claim 20, wherein generating the text prompt information according to the recognition result comprises:
determining position information of the occluded object with the relative distance not greater than the safety threshold, and adjusting a display position of the text prompt information according to the position information, so that the text prompt information is located beside the corresponding occluded object.

22. The electronic device of claim 12, wherein after adjusting the display transparency of the virtual object based on the relative distance, the acts further comprise:
detecting a light intensity of a realistic environment around the user; and
performing, in response to the light intensity being less than a preset threshold, differential display of the occluded object with the relative distance not greater than the safety threshold.
